(19) United States
(12) Patent Application Publication
(10) Pub. No.: US 2026/0071468 A1
(43) Pub. Date: Mar. 12, 2026

(54) SMART HANDCUFF DEVICES AND METHODS OF USE

(71) Applicant: Evidence Tools Company, Inc., Fort Lauderdale, FL (US)

(72) Inventors: Chase Alexander Lawson, Severna Park, MD (US); Michael Joseph Mahon, Severna Park, MD (US); Robert Stewart McKeeman, Fort Lauderdale, FL (US); Edward Wyrwas, Severn, MD (US)

(21) Appl. No.: 19/320,395

(22) Filed: Sep. 5, 2025

Related U.S. Application Data
(60) Provisional application No. 63/691,709, filed on Sep. 6, 2024.
(60) Provisional application No. 63/741,168, filed on Jan. 2, 2025.

(51) Int. Cl. E05B 75/00

(52) U.S. Cl. CPC E05B 75/00

(57) ABSTRACT

Various implementations include a smart handcuff device. The device includes a casing, a movable arm, a locking mechanism, and a distance sensor. The casing defines a casing chamber. The movable arm is hingedly coupled to the casing. The casing and the movable arm are configurable to at least partially form a closed loop having an inwardly facing surface. The locking mechanism is disposed within the casing chamber and includes a pawl and a spring. The pawl is movable between an engaged position and a disengaged position. The pawl is engageable with the arm in the engaged position and is disengaged from the arm in the disengaged position. The pawl is biased by the spring toward the engaged position and is urgable toward the disengaged position. The distance sensor is configured to measure the distance from the distance sensor to a surface facing the inwardly facing surface of the closed loop.

### BACKGROUND

The fundamental design of modern restraint devices, also known as handcuffs, has not changed since the initial handcuff was invented in 1912. The design of handcuffs has not changed significantly since that time. While minor refinements have been made to the manufacturing process, method of construction and double locking mechanisms, no substantial improvements have been made, especially with respect to the introduction of electronic components, Internet of Things (IOT), or telecommunications capabilities.

The standard pair of handcuffs issued by virtually every police, investigative, correctional, and security agency is strictly mechanical in nature. It consists of two adjustable metal rings connected by a chain or a hinge. Each ring can be closed by a locking mechanism to a varying diameter to become a solid ring that is slightly larger than the diameter of the detainee's wrist. The ring typically has a double-locking mechanism that allows the handcuff to be locked into a position with a designated level of safety gap. This function is a preventative measure to avoid cutting off blood flow and/or otherwise causing physical injury to the arm, wrist, or hand, while providing a level of fit appropriate to avoid the detainee extracting their hand from the handcuff ring.

A non-secured or loose handcuff poses a threat of injury to law enforcement officers and the public alike, providing an opportunity for escape which may thereby expose other persons to an element of danger, allowing a detainee to assault another with the sharp edge of the moveable locking arm, or use the device as a means of strangulation. Numerous American law enforcement officers have been permanent disabled or killed as a result of a detainee defeating or circumventing detention protocols and the intended use of the handcuff devices, including instances of maneuvering the handcuffs from a posterior to an anterior position, detainees under the influence of a controlled dangerous substances that are able to break the device with unusual muscular strength, and prisoners which conceal a key on their person and surreptitiously unlock the device.

Presently, there is no ability for the handcuff device to positively confirm, monitor or report that the handcuff device is in fact locked, has become unlocked, if the double lock is engaged, if the handcuff lock position changed while on the detainee, when the handcuff was locked into place and when it was unlocked, or a report a unique ID that positively confirms which set of handcuffs were used to restrain the detainee. If the detainee struggles while being handcuffed, it is often their goal is to cause the handcuff to be improperly secured, where the detainee can possibly extract their hand from the handcuff ring while in custody. Furthermore, in many jurisdictions there is a statutory requirement limiting the time that a detainee can be restrained in handcuffs—often two hours. Often a detainee will claim they were in restraint for longer than the statutory maximum allowed

Presently, law enforcement officers are required to place their 4th finger opposite the thumb (‘the pinky finger’) inside the handcuff between the wrist and cuff, to check for proper fitting. This poses a significant risk to the safety of the officer when restraining an uncooperative, combative detainee. The officer has a non-trivial risk that their digit can be injured, perhaps causing permanent disfigurement, and forcing the officer to prematurely leave his or her employment with a service pension. The risk is so significant that the “Best Practice” procedure requires an officer to use their non-dominant hand “pinky finger” to perform the safety clearance check, so that their dominant hand used for handling their weapon is not compromised. For all these reasons, an Officer ‘pinky finger’ wrist clearance safety check is often missed or skipped altogether. Furthermore, given the wide variations in hand sizes and the diameter of any particular officer's ‘pinky finger’, the clearance check distance can never be consistent. This increases the officer safety risk that a detainee might be able to withdraw their hand from the handcuff even though the wrist clearance safety check was performed. In addition, there is no independent validation or reporting that the handcuff clearance safety check was actually performed. Which means there is no proof the safety check was performed. There can always be a possible ‘He Said, She Said’ dispute about whether the safety check was performed.

The “Pinky finger” safety clearance test was the best available when the mechanical handcuff patent was issued in 1912 and the commonly accepted current design was first sold in 1932. A mechanical only handcuff design and the “Pinky Finger” clearance test continues to be the “Best Practice” standard for public safety agency procedures and training, and for vendors skilled in the art of handcuff restraint design and manufacturing even today.

The current state of the art handcuff mechanical design requires that handcuffs be manually ‘double-locked’ to prevent further tightening when pressure is applied to the outside of the cuff, such as when the subject is seated. This double-lock check can also be missed, which can potentially cause serious physical injury and permanent disfigurement to the detainee, including loss of sensation in the fingers. Failed double-lock validation also creates civil liability for the Public Safety agency and officer.

The current legacy but still state of the art mechanical handcuff design—currently over 90 years old—also lacks any ability to monitor key biometric indicators such as heart rate that could alert Officers and Central Dispatch that a detainee experiencing a potential medical emergency. Real time Biometric reporting can automatically generate alerts to the Officer and Central Dispatch, summon aid, and ultimately help prevent in-custody injury or death.

Strictly mechanical handcuffs provide no feedback to the officer, exposes the officer and detainee to a risk of personal injury, and exposes the governmental jurisdiction to the risk of civil liability damages. The current handcuff mechanical-only design fails to capture any evidentiary audit trail data such as Date/Time the handcuffs were engaged on the detainee, the double-lock setting of an engaged handcuff, the detainee uniform standard wrist safety clearance gap check was performed, the detainee wrist safety clearance gap distance, and Date/Time when the handcuffs were removed, that can be used to support bona-fide claims, refute handcuff abuse claims of frivolous nature, and provide actionable data to assist in the prosecution of suspected offenders. In conjunction with body worn cameras, video audit trail evidence of the Date/Time the handcuffs were engaged and released on the detainee and evidentiary video proof that the wrist safety clearance check was performed can be captured. In addition, body cameras can capture video evidence of the condition of the detainee wrists before the handcuffs were engaged on the detainee, and the condition of the detainee wrists after the handcuffs were removed. The combination of smart handcuffs, accessories such as specialized handcuff keys with built-in wrist safety clearance tools, and body camera video of the detainee wrists before and after handcuffs are engaged and released can provide an evidentiary audit trail of detainee pre-existing and/or self-inflicted wrist injuries as well as defense against abuse claims of a frivolous or fraudulent nature.

There are a growing number of handcuffs 42 U.S. C. Section 1983 “Excessive Use of Force/Police Misconduct” complaints and a commensurate expanding base of case law. In particular, there is a body of claims that Public Safety officers can lose Qualified Immunity and therefore be personally exposed to civil and criminal liability for excessive use of force for unnecessarily tight handcuffs. The threshold for alleging excessive use of force based upon tight handcuffs is perceived to be very low in the current legal and political environment. Case law examples include:

McGrew v. Duncan, 937 F.3d 664 (6th Cir. 2019) “Allegations of bruising and wrist marks [from handcuffs] create a genuine issue of material fact” that bar the granting of qualified immunity.

Sebastián v. Ortiz, 2019 (11th Cir. 2019) Police officers are not entitled to qualified immunity when he or she intentionally applies unnecessarily tight handcuffs to an arrestee who is neither resisting arrest nor attempting to flee.

Hughey v. Easlick, 3 F.4th 283 (6th 2021). In a section 1983 excessive force and deliberate indifference case, the court denied qualified immunity to an officer where an arrestee alleged that the officer applied handcuffs too tightly during a traffic stop, ultimately tearing the arrestee's rotator cuff. The court stated that to survive summary judgment, a plaintiff must present evidence that they complained about the tightness, were ignored, and that injury resulted. The court indicated that injury may include “ring marks” on the wrist or bruises. It also indicated that the arrestee's request that the handcuffs be removed “indicates that she was suffering from some degree of pain” and so constituted a complaint about the tightness of the handcuffs.

Mglej v. Gardner, 974 F.3d 1151 (10th 2020). In a section 1983 excessive force case, the court denied qualified immunity to an officer who handcuffed an arrestee and initially ignored the arrestee's complaints that the handcuffs were too tight. The officer later attempted to loosen the handcuffs, but they broke, leading the officer to use tools from his own garage to pry the handcuffs off, causing significant pain and long-term nerve damage. The court noted the minor nature of the suspected crime—a petty larceny—the lack of resistance by the arrestee, and the arrestee's complaints as well as the protracted process of removing the handcuffs.

Templeton v. Jarmillo, 28 F.4th 618 (5th 2022). A section 1983 excessive force claim was dismissed where the plaintiff alleged that during a welfare check—which turned into an involuntary commitment—police handcuffed him tightly enough to cause “extreme pain” such that his legs buckled, his shoulder spasmed, and he asked for the handcuffs to be removed. The reviewing court affirmed, ruling that “[t]ight handcuffing alone, even where a detainee sustains minor injuries, does not present an excessive force claim,” and distinguishing circuit precedent about prolonged handcuffing causing serious and permanent injury.

Ketcham v. City of Mount Vernon, 992 F.3d 144 (2d Cir. 2021). In a case involving claims under state law as well as claims of excessive force under section 1983, the court reversed a lower court's grant of summary judgment to officers who took a man into custody, allegedly handcuffed him too tightly, and hit his head on the door frame of the officer's patrol car. The court stated that the “established law of this Circuit makes clear that the excessive tightening of handcuffs after an explicit verbal complaint of pain is made violates the Fourth Amendment,” and rejected the district court's reasoning that the plaintiff's injuries were de minimis because he did not seek medical treatment or prove lasting damage.

There are also variations in US State and Local jurisdiction law regarding excessive use of force. Clearly there are also political differences across US jurisdictions in whether and how ‘excessive use of force’ charges are, or are not, prosecuted. Furthermore, mechanical handcuffs lack any capability to be configured to comply with the specific use of force rules and procedures for any given jurisdiction.

Claims of public safety or correctional custodial abuse can trigger public disturbances and civil unrest if not addressed transparently and with tangible evidence shared with the public. Recent events have included riots, extensive physical and monetary damage to both public and private property, injuries, and even deaths. Longer term effects include major negative economic effects, including mass amounts of businesses relocating or closing, reduced real property values, and swift population shifts. Therefore, local incomes, and property, school, and sales tax revenue, can all decline. Lack of investment can cause Economic decay that becomes a downward spiral on top of prior Economic decay. Communities have a strong interest in fair and transparent treatment of detainees.

There has been a commensurate increase on the part of some communities to distrust in Public Safety and Corrections. There have been many calls to ‘Defund the Police’. Unfortunately, some members of the public will assume that public safety and correctional officers are guilty of abuse unless they can prove they are innocent. A modest cost increase for enhanced handcuffs that can provide real-time fact-based transparent reporting should increase public confidence in the fairness of Public Safety and Corrections enforcement, and possibly help avoid many times larger property damage and tax revenue loss caused by civil unrest. As an example, the aftermath of the George Floyd death totaled millions of dollars in property damage, and significant economic losses from closed businesses and reduced economic activity and development.

The enhanced handcuff device's immediate reporting feedback can be used to promptly resolve claims of handcuff abuse, so that Public Safety and Corrections officers are not placed on Administrative Leave for weeks or months, while a Detainee claim of handcuff abuse is adjudicated. Long periods of Administrative Leave obviously cause an Officer to not be available to perform their assigned duties. Other Officers must fill in the gap, typically at significant overtime cost. More importantly, there is a short-staffing safety risk to the remaining Officers. Administrative Leave event documentation becomes part of the Officer's personnel file. As a practical matter, Administrative Leave events can negatively impact an Officer's performance review and career progression, even if the investigation eventually shows the Officer acted in Good Faith, and worked to minimize human, physical property, and economic damage.

Handcuffs with electronic data reporting can include the handcuff's unique serial number similar to a MAC address. The serial number, date and time, GPS location coordinates, and battery state can provide irrefutable facts regarding the interrogatives of Who, What, When, Where, and for How Long. Officers can identify and locate their assigned handcuffs. Officers and Central Dispatch can receive alerts regarding biometric risks, handcuff operational state, remaining available restraint elapsed time per published policy, and remaining battery life.

There are clear benefits to Detainees, Officers, and Departments to having real-time, independent fact-based proof of the safe use of Handcuffs in Public Safety and Corrections. In cases of actual handcuff abuse, the system can quickly provide incontrovertible fact-based evidence to fairly resolve a claim of abuse.

Real-time data capture technology has advanced significantly in the last ten years. The communications infrastructure now exists and is ready to support significant enhancements to detainee restraints that address the shortcomings of current mechanical handcuffs. A device that more directly monitors detainee vital signs and improves overall wellbeing thereof, prevents harm to law enforcement officers, and provides for the greater protection of citizens'rights is now possible by incorporating real-time data capture and real-time wireless communications, the internet of things (IOT), advancements in the GovTech ecosystem, and enhancements in data transfer infrastructure.

### SUMMARY

Various implementations include a smart handcuff device. The device includes a casing, a movable arm, a locking mechanism, and a distance sensor. The casing defines a casing chamber. The movable arm is hingedly coupled to the casing. A distal end portion of the movable arm includes one or more arm teeth. The casing and the movable arm are configurable to at least partially form a closed loop having an inwardly facing surface. The locking mechanism is disposed within the casing chamber. The locking mechanism includes a pawl and a lock spring. The pawl has one or more pawl teeth for engaging the arm teeth. The pawl is movable between an engaged position and a disengaged position. The one or more pawl teeth are engageable with the one or more arm teeth in the engaged position and the one or more pawl teeth are disengaged from the one or more arm teeth in the disengaged position. The lock spring is for biasing the pawl toward the engaged position. The pawl is urgable toward the disengaged position. The distance sensor is configured to measure a distance from the distance sensor to a surface facing the inwardly facing surface of the closed loop.

In some implementations, the device further includes a controller having a processor and a system memory. In some implementations, the processor is in operative communication with the distance sensor. In some implementations, the processor executes computer-readable instructions stored on the system memory. In some implementations, the instructions cause the processor to cause the system memory to receive distance input from the distance sensor, compare the distance input to a predetermined distance threshold, and generate a distance signal if the distance input is below the predetermined distance threshold. In some implementations, the instructions further cause the processor to cause the distance signal to be wirelessly transmitted from the device. In some implementations, the device further includes a Bluetooth transceiver. In some implementations, the distance signal includes a timestamp.

In some implementations, the device further includes a heart-rate sensor configured to sense a heartbeat adjacent the heart-rate sensor. In some implementations, the device further includes a controller having a processor and a system memory. In some implementations, the processor is in operative communication with the heart-rate sensor. In some implementations, the processor executes computer-readable instructions stored on the system memory. In some implementations, the instructions causes the processor to cause the system memory to receive heart-rate input from the heart-rate sensor, compare the heart-rate input to a predetermined heart-rate threshold, and generate a heart-rate signal if the heart-rate input is below the predetermined heart-rate threshold.

In some implementations, the device further includes a temperature sensor configured to sense a temperature adjacent the temperature sensor. In some implementations, the device further includes a controller having a processor and a system memory. In some implementations, the processor being in operative communication with the temperature sensor. In some implementations, the processor executes computer-readable instructions stored on the system memory. In some implementations, the instructions cause the processor to cause the system memory to receive temperature input from the temperature sensor, compare the temperature input to a predetermined temperature range, and generate a temperature signal if the temperature input is outside of the predetermined temperature range.

In some implementations, the device further included an accelerometer configured to sense acceleration of the device. In some implementations, the device further includes a controller having a processor and a system memory. In some implementations, the processor is in operative communication with the accelerometer. In some implementations, the processor executes computer-readable instructions stored on the system memory. In some implementations, the instructions cause the processor to cause the system memory to receive acceleration input from the accelerometer, compare the acceleration input to a predetermined acceleration threshold, and generate an acceleration signal if the acceleration input is above the predetermined acceleration threshold.

In some implementations, the device further includes a microphone. In some implementations, the device further includes a speaker.

In some implementations, the device further includes an onboard power source. In some implementations, the device further includes one or more charging ports for providing electrical energy to the power source.

In some implementations, the locking mechanism is a double locking mechanism. In some implementations, the lock spring is slidable between a double locked position and a double unlocked position. In some implementations, a portion of the lock spring prevents the pawl from moving between the engaged position and the disengaged position in the double locked position. In some implementations, the portion of the lock spring does not prevent the pawl from moving between the engaged position and the disengaged position in the double unlocked position.

In some implementations, the double locking mechanism includes a double lock sensor configured to sense the lock spring when the lock spring is in the double locked position. In some implementations, the double lock sensor is configured not to be able to sense the lock spring when the lock spring is in the double unlocked position.

In some implementations, the device further includes a controller having a processor and a system memory. In some implementations, the processor is in operative communication with the double lock sensor. In some implementations, the processor executes computer-readable instructions stored on the system memory. In some implementations, the instructions causes the processor to cause the system memory to receive double lock position input from the double lock sensor when the double lock sensor senses the lock spring, and generate a double lock signal if the system memory receives the double lock position input.

In some implementations, the double lock signal includes a time stamp.

Various other implementations include a smart handcuff system. The system includes a smart handcuff device as disclosed herein and a second handcuff coupled to the device. In some implementations, the device is a first smart handcuff device and the second handcuff is a second smart handcuff device.

Various other implementations include a smart handcuff device. The device includes a casing, a movable arm, a double locking mechanism, and a double lock sensor. The casing defines a casing chamber. The movable arm is hingedly coupled to the casing. A distal end portion of the movable arm includes one or more arm teeth. The casing and the movable arm are configurable to at least partially form a closed loop having an inwardly facing surface. The double locking mechanism is disposed within the casing chamber. The double locking mechanism includes a pawl and a lock spring. The pawl has one or more pawl teeth for engaging the arm teeth. The pawl is movable between an engaged position and a disengaged position. The one or more pawl teeth are engageable with the one or more arm teeth in the engaged position and the one or more pawl teeth are disengaged from the one or more arm teeth in the disengaged position. The lock spring is for biasing the pawl toward the engaged position. The pawl is urgable toward the disengaged position. The lock spring is slidable between a double locked position and a double unlocked position. A portion of the lock spring prevents the pawl from moving between the engaged position and the disengaged position in the double locked position. The portion of the lock spring does not prevent the pawl from moving between the engaged position and the disengaged position in the double unlocked position. The double lock sensor is configured to sense the lock spring when the lock spring is in the double locked position. The double lock sensor is configured not to be able to sense the lock spring when the lock spring is in the double unlocked position.

In some implementations, the device further includes a controller having a processor and a system memory. In some implementations, the processor is in operative communication with the double lock sensor. In some implementations, the processor executes computer-readable instructions stored on the system memory. In some implementations, the instructions cause the processor to cause the system memory to receive double lock position input from the double lock sensor when the double lock sensor senses the lock spring, and generate a double lock signal if the system memory receives the double lock position input. In some implementations, the instructions further cause the processor to cause the double lock signal to be wirelessly transmitted from the device. In some implementations, the device further includes a Bluetooth transceiver. In some implementations, the double lock signal includes a time stamp.

In some implementations, the device further includes a distance sensor configured to measure the distance from the distance sensor to a surface facing the inwardly facing surface of the closed loop. In some implementations, the device further includes a controller having a processor and a system memory. In some implementations, the processor is in operative communication with the distance sensor. In some implementations, the processor executes computer-readable instructions stored on the system memory. In some implementations, the instructions cause the processor to cause the system memory to receive distance input from the distance sensor, compare the distance input to a predetermined distance threshold, and generate a distance signal if the distance input is below the predetermined distance threshold. In some implementations, the distance signal includes a timestamp.

In some implementations, the device further includes a heart-rate sensor configured to sense a heartbeat adjacent the heart-rate sensor. In some implementations, the device further includes a controller having a processor and a system memory. In some implementations, the processor is in operative communication with the heart-rate sensor. In some implementations, the processor executes computer-readable instructions stored on the system memory. In some implementations, the instructions cause the processor to cause the system memory to receive heart-rate input from the heart-rate sensor, compare the heart-rate input to a predetermined heart-rate threshold, and generate a heart-rate signal if the heart-rate input is below the predetermined heart-rate threshold.

In some implementations, the device further includes a temperature sensor configured to sense a temperature adjacent the temperature sensor. In some implementations, the device further includes a controller having a processor and a system memory. In some implementations, the processor is in operative communication with the temperature sensor. In some implementations, the processor executes computer-readable instructions stored on the system memory. In some implementations, the instructions cause the processor to cause the system memory to receive temperature input from the temperature sensor, compare the temperature input to a predetermined temperature range, and generate a temperature signal if the temperature input is outside of the predetermined temperature range.

In some implementations, the device further includes an accelerometer configured to sense acceleration of the device. In some implementations, the device further includes a controller having a processor and a system memory. In some implementations, the processor is in operative communication with the accelerometer. In some implementations, the processor executes computer-readable instructions stored on the system memory. In some implementations, the instructions cause the processor to cause the system memory to receive acceleration input from the accelerometer, compare the acceleration input to a predetermined acceleration threshold, and generate an acceleration signal if the acceleration input is above the predetermined acceleration threshold.

In some implementations, the device further includes a microphone.

In some implementations, the device further includes an onboard power source. In some implementations, the device further includes one or more charging ports for providing electrical energy to the power source.

Various other implementations include a smart handcuff system. The system includes a smart handcuff device as disclosed herein and a second handcuff coupled to the device. In some implementations, the device is a first smart handcuff device and the second handcuff is a second smart handcuff device.

Various other implementations include a smart handcuff device. The device includes a casing, a movable arm, a locking mechanism, and a distance test indicator. The casing defines a casing chamber. The movable arm is hingedly coupled to the casing. A distal end portion of the movable arm includes one or more arm teeth. The casing and the movable arm are configurable to at least partially form a closed loop having an inwardly facing surface. The locking mechanism is disposed within the casing chamber. The locking mechanism includes a pawl and a lock spring. The pawl has one or more pawl teeth for engaging the arm teeth. The pawl is movable between an engaged position and a disengaged position. The one or more pawl teeth are engageable with the one or more arm teeth in the engaged position and the one or more pawl teeth are disengaged from the one or more arm teeth in the disengaged position. The lock spring is for biasing the pawl toward the engaged position. The pawl is urgable toward the disengaged position. The distance test indicator is disposed along an inwardly facing surface of the closed loop and configured to be detectable by an external device.

In some implementations, the distance test indicator includes one or more magnets. In some implementations, the distance test indicator includes one or more RFID tags.

In some implementations, the locking mechanism is a double locking mechanism. In some implementations, the lock spring is slidable between a double locked position and a double unlocked position. In some implementations, a portion of the lock spring prevents the pawl from moving between the engaged position and the disengaged position in the double locked position. In some implementations, the portion of the lock spring does not prevent the pawl from moving between the engaged position and the disengaged position in the double unlocked position.

In some implementations, the double locking mechanism includes a double lock switch. In some implementations, the double lock switch includes a set of contacts. In some implementations, the contacts are electrically coupled in the double locked position and electrically uncoupled in the double unlocked position. In some implementations, the contacts are electrically coupled to the antenna of the RFID tag such that the RFID tag is unable to transmit a signal when the handcuff device is in the double unlocked position. In some implementations, the contacts provide information regarding the double lock mechanism to the RFID tag so that the RFID tag's signal includes double lock status information.

In some implementations, the device does not include a power source.

Various other implementations include a smart handcuff system. The system includes a smart handcuff device as disclosed herein and a second handcuff coupled to the device. In some implementations, the device is a first smart handcuff device and the second handcuff is a second smart handcuff device.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a perspective view of a smart handcuff system, according to one implementation.

FIG. 2A is a rear view of a smart handcuff device of the smart handcuff system of FIG. 1.

FIG. 2B is a rear view of the smart handcuff device of FIG. 2A with the first plate of the casing removed.

FIG. 3A is a rear detail view of the smart handcuff device of FIG. 2B.

FIG. 3B is a front detail view of the smart handcuff device of FIG. 2A with the second plate of the casing removed.

FIG. 4A is a front detail view of the smart handcuff device of FIG. 2B with the features within the casing chamber removed.

FIG. 4B is a front perspective detail view of the smart handcuff device of FIG. 4A with an additional middle shim removed.

FIGS. 5A and 5B show perspective views of the middle shims of the smart handcuff device of FIG. 2A.

FIG. 6 shows a bottom perspective view of the smart handcuff device of FIG. 2A.

### DETAILED DESCRIPTION

The devices, systems, and methods disclosed herein provide for a system and method for enhanced handcuffs with real-time electronic data capture and reporting that independently validates handcuffs were used in accordance with jurisdiction statutory requirements for the safe restraint of detainees. In addition, the devices, systems, and methods disclosed herein can provide warning of detainee distress and potential injury. Furthermore, the devices, systems, and methods disclosed herein can provide notice of upcoming restraint maximum elapsed-time violations. The devices, systems, and methods disclosed herein can therefore help protect Public Safety staff and agencies from 42 U.S. C. § 1983 “Excessive Use of Force/Police Misconduct” claims, loss of Officer Qualified Immunity, and the risk and impact of civil unrest on the community.

The devices, systems, and methods disclosed herein provide for enhanced mechanical handcuff restraints to capture and report real-time operational state, detainee biometric, and safety clearance data. The safety clearance wand incorporated as part of the handcuff key provides a consistent and uniform safety clearance of the handcuff on the detainee's wrist. The wand also avoids the Officer from having to use their non-dominant hand 4^{th} finger (the “pinky finger”) as the safety clearance measurement method, which is a safety risk to the Officer and nearby Citizens. The wand incorporates data capture that validates that the safety clearance check was actually performed. A data capture and wireless communications module embedded in the handcuff hinge reports operational state data such as when the restraint was placed on and removed from the detainee, the double-lock setting, and whether the handcuff is actually locked. A multi-axis accelerometer reports the motion and force information of the handcuffs while in use. An embedded sensor(s) reports heart rate and other biometric data that indicate that the detainee is in medical distress or is actively struggling to remove the handcuff. All this operational state and rate of change data is encrypted and securely stored in the handcuff data capture module. Business rules and methods control when operational data and alerts are communicated via secure wireless communications to an Officer's cell phone, body camera, vehicle area network, in-car video camera system, and other means and methods of communicating handcuff status and alerts to nearby Officers, Central Dispatch, and other Public Safety and Corrections support and warning systems. The data is further archived in Records Management and Evidence repositories, where it is available to District Attorneys, Prosecutors, Defense Counsel, Court Clerks, and other Judiciary staff for controlled access to handcuff data as evidence.

A key wand of a handcuff key and double-lock pin can be used to lock and unlock a double-locking handcuff. The double-lock mechanism mechanically locks the handcuff into a set diameter. A standard diameter mechanical wrist clearance safety measurement tool can replace the highly variable manual “pinky finger” clearance safety test. A data capture and wireless communications module is securely embedded in the handcuff. The embedded heart rate and temperature telemetry sensor captures real-time detainee biometrics data. The embedded multi-axis accelerometer captures the distance and force of acceleration and deceleration movements that indicate if a detainee is attempting to remove their hand from the handcuff ring or injuring their wrist. The data collected by the accelerometer can be used to determine movement and position (e.g., sitting, running, laying on back/side) of the user. A passive NFC reader or magnetic sensor identifies when the safety clearance distance wand is inserted between the detainee wrist and handcuff ring and allows the officer to adjust the double-lock to provide a safe and secure clearance distance. The distance sensor(s) provides accurate measurement of distance from the detainee wrist to hand cuff. A microphone is used to sense handcuff engagement, and other discrete state information of the hand cuffs. A microswitch is used to sense state of the double locking mechanism.

The advantages of the devices, systems, and methods disclosed herein are safe and secure restraint of a detainee, while capturing and reporting periodic and real-time operational state and alert status evidence data. Until the devices, systems, and methods disclosed herein, handcuff restraints have been mechanical-only devices with no autonomous operational state or alert reporting capability of when the handcuff was placed on the detainee, and when it was removed. The devices, systems, and methods disclosed herein capture and store an indisputable audit trail and real-time reporting of alerts and operational legal evidence. The safety and security distance wand provides a uniform standard clearance distance that protects the safety of both the detainee and the officer. The integrated data capture and wireless reporting capability provides fact-based evidence about the use of the restraint, without being a distraction or burden on the Officer to manually capture, monitor, and report handcuff restraint data, and that cannot be manually manipulated by the Officer. Fact-based transaction and event data can quickly be provided transparently to the other Law Enforcement and Corrections agencies, the Courts system, Defense Attorneys, Political Leaders, Public Information Officers, and the Media. Misconceptions and adverse public reaction based upon unfounded speculation can be addressed quickly before public disturbances lead to injuries, deaths, property damage, and loss of faith and trust in civic institutions.

Various implementations include a smart handcuff device. The device includes a casing, a movable arm, a locking mechanism, and a distance sensor. The casing defines a casing chamber. The movable arm is hingedly coupled to the casing. The distal end portion of the movable arm includes one or more arm teeth. The casing and the movable arm are configurable to at least partially form a closed loop having an inwardly facing surface. The locking mechanism is disposed within the casing chamber. The locking mechanism includes a pawl and a lock spring. The pawl has one or more pawl teeth for engaging the arm teeth. The pawl is movable between an engaged position and a disengaged position. The one or more pawl teeth are engageable with the one or more arm teeth in the engaged position and the one or more pawl teeth are disengaged from the one or more arm teeth in the disengaged position. The lock spring is for biasing the pawl toward the engaged position. The pawl is urgable toward the disengaged position. The distance sensor is configured to measure the distance from the distance sensor to a surface facing the inwardly facing surface of the closed loop.

Various other implementations include a smart handcuff device. The device includes a casing, a movable arm, a double locking mechanism, and a double lock sensor. The casing defines a casing chamber. The movable arm is hingedly coupled to the casing. A distal end portion of the movable arm includes one or more arm teeth. The casing and the movable arm are configurable to at least partially form a closed loop having an inwardly facing surface. The double locking mechanism is disposed within the casing chamber. The double locking mechanism includes a pawl and a lock spring. The pawl has one or more pawl teeth for engaging the arm teeth. The pawl is movable between an engaged position and a disengaged position. The one or more pawl teeth are engageable with the one or more arm teeth in the engaged position and the one or more pawl teeth are disengaged from the one or more arm teeth in the disengaged position. The lock spring is for biasing the pawl toward the engaged position. The pawl is urgable toward the disengaged position. The lock spring is slidable between a double locked position and a double unlocked position. A portion of the lock spring prevents the pawl from moving between the engaged position and the disengaged position in the double locked position. The portion of the lock spring does not prevent the pawl from moving between the engaged position and the disengaged position in the double unlocked position. The double lock sensor is configured to sense the lock spring when the lock spring is in the double locked position. The double lock sensor is configured not to be able to sense the lock spring when the lock spring is in the double unlocked position.

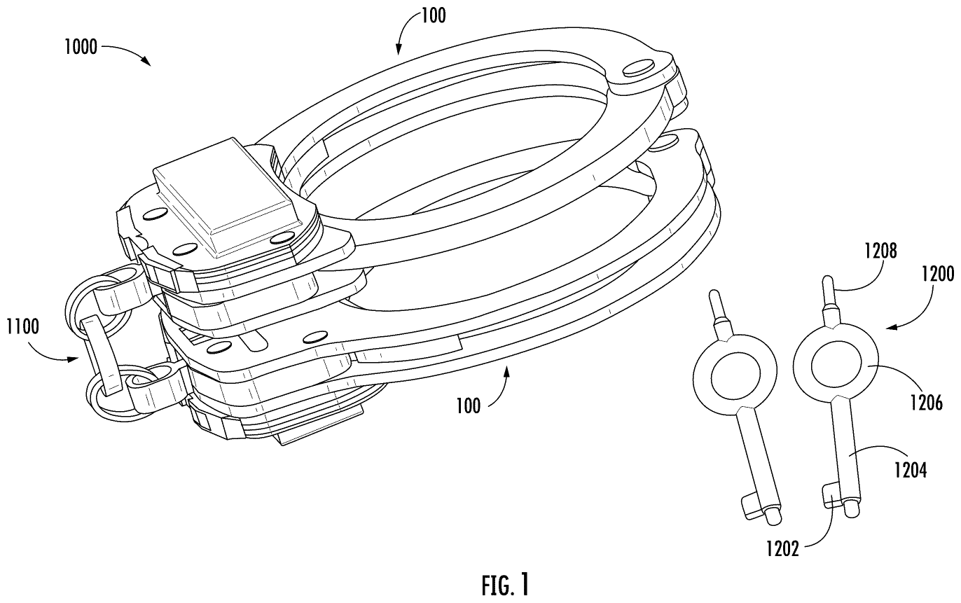

FIG. 1 shows a smart handcuff system 1000 including aspects of various implementations. The system 1000 includes a first smart handcuff device 100 and a second smart handcuff device 100 coupled to each other by a chain 1100. Each device 100 includes a casing 110, a fixed arm 130, a movable arm 140, a double locking mechanism 150, a controller 170, and various sensors.

Although the system 1000 shown in FIG. 1 includes two smart handcuff devices 100, in some implementations, the system includes only one smart handcuff device and a regular handcuff. In some implementations, the system includes a first smart handcuff including only some of the features of the smart handcuff devices disclosed herein, and the second smart handcuff device includes some of the same features or other features of the smart handcuff devices disclosed herein.

Although the first smart handcuff device 100 and the second smart handcuff device 100 of the system 1000 of FIG. 1 are coupled to each other with a chain 1100, in some implementations, the first smart handcuff device and the second smart handcuff device are coupled to each other by a hinge or any other secure linking mechanism. In some implementations, the first smart handcuff device and the second smart handcuff device are rigidly coupled to each other.

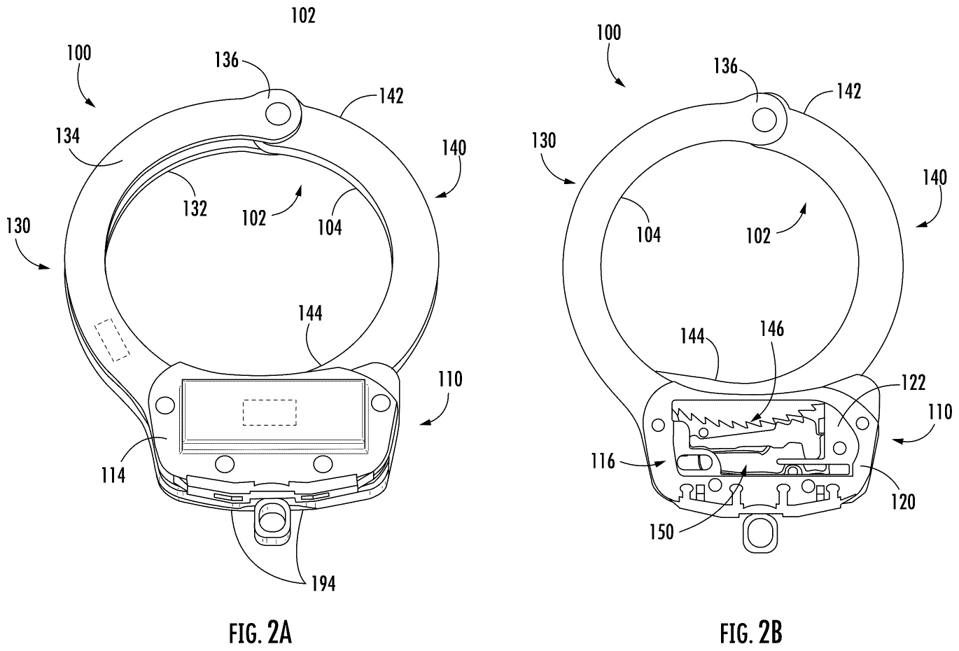

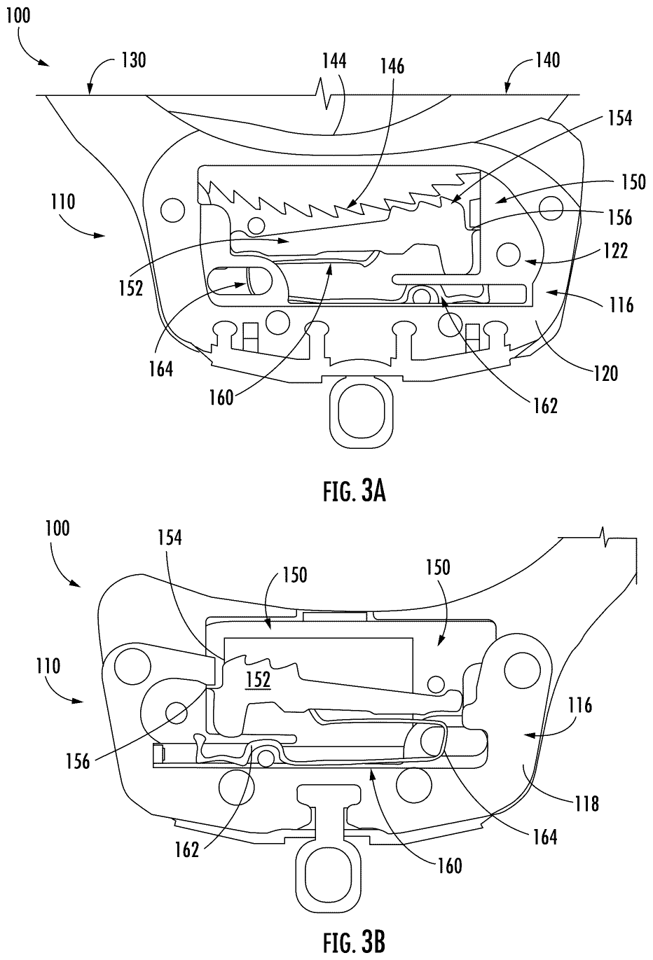

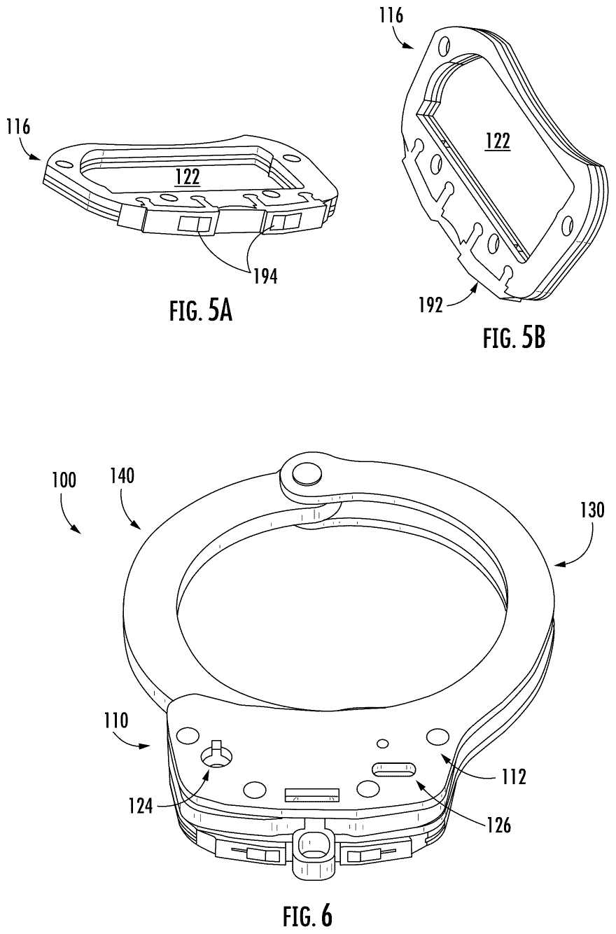

FIGS. 2A-6 show a single smart handcuff device 100 of the smart handcuff system 1000 shown in FIG. 1. The casing 110 of the device 100 includes a first plate 112, a second plate 114, and middle shims 116. A first portion 132 of the fixed arm 130 extends from the first plate 112, and a second portion 134 of the fixed arm 130 extends from the second plate 114. The first portion 132 of the fixed arm 130 and the second portion 134 of the fixed arm 130 combine to form the fixed arm 130. The first plate 112 is coupled to a first side 118 of the middle shims 116, and the second plate 114 is coupled to a second side 120 of the middle shims 116 to sandwich the middle shims 116 between the first plate 112 and the second plate 114.

The middle shims 116 define a casing chamber 118 extending from the first side 118 of the middle shim 116 to the second side 120 of the middle shim 116.

The distal end portions 136 of each of the first portion 132 of the fixed arm 130 and the second portion 134 of the fixed arm 130 are hingedly coupled to the proximal end portion 142 of the movable arm 140. The movable arm 140 is movable toward a closed position in which the casing 110, the fixed arm 130, and the movable arm 140 form a closed loop 102 having an inwardly facing surface 104 and an open position in which the distal end portion 144 of the movable arm 140 does not contact the casing 110.

The double locking mechanism 150 is disposed within the casing chamber 122. The double locking mechanism 150 includes a pawl 152 and a lock spring 160.

The pawl 152 (also called a lock bar) has one or more pawl teeth 154, and the distal end portion 144 of the movable arm 140 includes one or more arm teeth 146. The pawl 152 is movably oriented within the casing chamber 122 such that, when the movable arm 140 is rotated about the hinged coupling relative to the fixed arm 130 and the casing 110 to form a closed loop 102, the one or more pawl teeth 154 can engage the one or more arm teeth 146.

The pawl 152 is movable between an engaged position and a disengaged position. The one or more pawl teeth 154 are engageable with the one or more arm teeth 146 in the engaged position, and the one or more pawl teeth 154 are disengaged from the one or more arm teeth 146 in the disengaged position.

The pawl teeth 154 and arm teeth 146 are angled relative to each other to work as a ratcheting mechanism. Each of the arm teeth 146 and the pawl teeth 154 are angled such that, when the movable arm 140 moves toward a closed position, the arm teeth 146 can slide over the inclined surfaces of the pawl teeth 154. But, when a force is applied to the movable arm 140 to attempt to move the movable arm 140 toward an open position, the arm teeth 146 and pawl teeth 154 are angled such that they obstruct each other and prevent the movement of the movable arm 140 relative to the casing 110. This creates a ratcheting mechanism that allows the movable arm 140 to move toward the closed position in both the engaged position and the disengaged position but only allows the movable arm 140 to move toward the open position in the disengaged position.

The lock spring 160 is positioned in the casing chamber 122 such that it biases the pawl 152 toward the engaged position. The pawl 152 is urgable toward the disengaged position by loading the lock spring 160. Thus, when the lock spring 160 is biasing the pawl 152 toward the engaged position, the closed loop 102 of the smart handcuff device 100 is locked. This is the first lock of the double locking mechanism 150.

The first plate 112 of the casing 110 defines a keyhole 124 through which a handcuff key 1200 can be inserted. The pawl 152 includes a ledge or protrusion 156 that is engageable by the bit 1202 of a handcuff key 1200 when the key 1200 is rotated about the longitudinal axis of the key shank 1204. The force from the bit 1202 of the handcuff key 1200 on the ledge or protrusion 156 of the pawl 152 as the handcuff key 1200 is rotated can cause the pawl 152 to load the lock spring 160 such that the pawl 152 moves from the engaged position toward the disengaged position. In the disengaged position, the arm teeth 146 are no longer engaged with the pawl teeth 154, and the movable arm 140 is movable from the closed position toward the open position.

The casing chamber 122 is configured to allow the lock spring 160 to slide within the casing chamber 122 between a double locked position and a double unlocked position. When the lock spring 160 is in the double locked position, a protruding portion 162 of the lock spring 160 is positioned relative to the pawl 152 to prevent the pawl 152 from moving between the engaged position and the disengaged position. Thus, even when a handcuff key 1200 is used to apply force to the ledge or protrusion 156 of the pawl 152, the movement of the pawl 152 is obstructed by the protruding portion 162 of the spring 160 to prevent the pawl 152 from moving toward the disengaged position. This is the second lock of the double locking mechanism 150. The lock spring 160 can slide from the double locked position to the double unlocked position. In the double unlocked position, the protruding portion 162 of the lock spring 160 is no longer positioned such that the protruding portion 162 of the lock spring 160 prevents the pawl 152 from moving between the engaged position and the disengaged position.

The first plate 112 of the casing 110 further defines a double lock slot 126. A catch portion 164 of the lock spring 160 is positioned such that the catch portion 164 is positioned behind the double lock slot 126 when the lock spring 160 is in both the double locked position and the double unlocked position. A double lock wand 1208 of a handcuff key 1200 extends from the bow 1206 of the handcuff key 1200. The double lock slot 126 is sized such that the double lock wand 1208 is insertable into the double lock slot 126 on both sides of the catch portion 164 of the lock spring 160 when the lock spring 160 is in both the double locked position and the double unlocked position. Movement of the double lock wand 1208 within the double lock slot 126 can apply force to the catch portion 164 of the lock spring 160 to cause the lock spring 160 to move between the double locked position and the double unlocked position.

Although the keyhole 124 and the double lock slot 126 are described herein as being defined by the first plate 112 of the casing 110, in some implementations, the second plate of the casing can also define a keyhole, a double lock slot, or both.

The controller 170 is disposed within the casing chamber 122 of the casing 110 of the device 100. The controller 170 includes a processor 172 and a system memory 174. The processor 172 is in operative communication with various sensors, as described herein. The processor 172 is configured to execute computer-readable instructions stored on the system memory 174.

A distance sensor 180 is disposed on the casing 110 of the device 100 shown in FIGS. 2A-6 and is positioned to measure the distance from the distance sensor 180 to a surface, such as a detainee's wrist disposed within the closed loop 102, facing the inwardly facing surface 104 of the closed loop 102. However, in some implementations, the distance sensor can be disposed along any portion of the device capable of measuring the distance from the distance sensor to a surface facing the inwardly facing surface of the closed loop.

The processor 172 is in operative communication with the distance sensor 180. The computer-readable instructions cause the processor 172 to cause the system memory 174 to receive distance input from the distance sensor 180. The distance input can relate to the distance from the distance sensor 180 to the surface facing the inwardly facing surface 104 of the closed loop 102.

The computer-readable instructions then cause the processor 172 to compare the received distance input to a predetermined distance threshold. This distance threshold can be based on a predetermined acceptable minimum distance from the distance sensor 180 to the surface facing the inwardly facing surface 104 of the closed loop 102.

The computer-readable instructions then cause the processor 172 to generate a distance signal if the distance input is below the predetermined distance threshold. A determination that the distance input is below the predetermined distance threshold could represent that the closed loop 102 of the device 100 has been tightened beyond the predetermined acceptable limit, which can create a safety concern for the detainee.

In some implementations, the computer-readable instructions can further cause the processor to compare the received distance input to a second predetermined distance threshold. This second distance threshold can be based on a predetermined acceptable maximum distance from the distance sensor to the surface facing the inwardly facing surface of the closed loop.

In such implementations, the computer-readable instructions can then cause the processor to generate a second distance signal if the distance input is above the second predetermined distance threshold. A determination that the distance input is above the second predetermined distance threshold could represent that the closed loop of the device is not tight enough and could allow the detainee to withdraw their wrist from the closed loop in the closed position, which can create a safety concern for the detainer.

The distance sensor 180 can be any kind of proximity or distance sensor, such as a Hall effect sensor, an inductive proximity sensor, a capacitive proximity sensor, an ultrasonic proximity sensor, a magnetic proximity sensor, a photoelectric sensor, an infrared (IR) sensor, a light detection and ranging (LiDAR) sensor, a time-of-flight (ToF) sensor, or an optical proximity sensor.

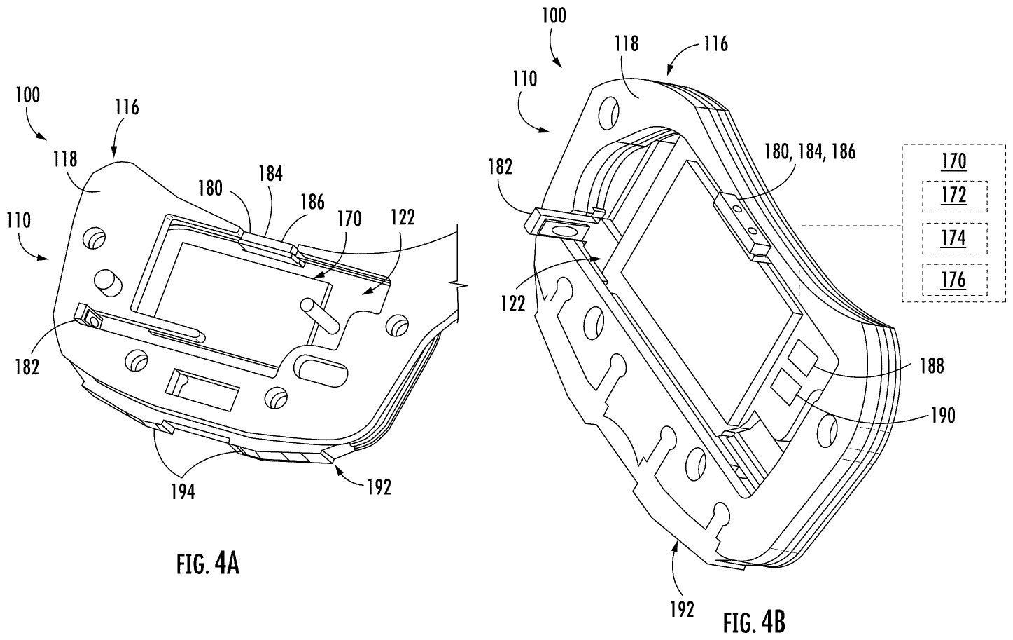

In some implementations, the device does not include a distance sensor, and includes a distance test indicator where the distance sensor would be located. In such implementations, a distance measuring device, such as a handcuff wand, can be used with the distance test indicator to determine if the handcuffs are applied too tightly. In one such implementation, the distance test indicator can include one or more magnets 180 located where the distance sensor 180 is included in the implementation shown in FIGS. 4A and 4B or disposed along any other portion of the inwardly facing surface of the closed loop. The handcuff wand can include a sensor, such as a Hall sensor, for detecting a magnetic field.

Thus, when the wand is used to determine tightness of the handcuffs, the Hall sensor detects the one or more magnets 180 in the handcuff device to confirm that a tightness test has been successfully completed. In some implementations, the device can include a distance sensor and one or more magnets.

In other implementations, the distance test indicator may include an RFID tag 180 located where the distance sensor 180 is included in the implementation shown in FIGS. 4A and 4B or disposed along any other portion of the inwardly facing surface of the closed loop. The handcuff wand can include an RFID reader such that, when the wand is used to determine tightness of the handcuffs, the RFID reader detects the RFID tag 180 in the handcuff device to confirm that a tightness test has been successfully completed. The RFID tag 180 can further transmit any additional information from other sensors of the handcuff device to the handcuff wand during the tightness determination. In some implementations, the device can include a distance sensor, an RFID tag, and/or one or more magnets.

In either or both implementations, the instructions further cause the processor 172 to cause the distance signal and/or the second distance signal to be wirelessly transmitted from the device 100. The device 100 shown in FIGS. 2A-6 includes a Bluetooth transceiver 176 to wirelessly transmit the distance signal and/or the second distance signal from the device 100, but in some implementations, the device includes a wireless router or any other mechanism for wirelessly transmitting the distance signal and/or the second distance signal from the device.

A double lock sensor 182 is disposed within the casing chamber 122 and is configured to sense the lock spring 160 when the lock spring 160 is in the double locked position. The double lock sensor 182 can be any kind of proximity or distance sensor, such as a Hall effect sensor, an inductive proximity sensor, a capacitive proximity sensor, an ultrasonic proximity sensor, a magnetic proximity sensor, a photoelectric sensor, an IR sensor, a LiDAR sensor, a ToF sensor, or an optical proximity sensor.

As discussed above, in some implementations, the device can include an RFID tag 180 that is readable by an external device, such as a handcuff wand. In some implementations, the RFID tag 180 can also transmit information about the double lock mechanism status. For example, the double lock sensor can include contacts that are electrically coupled in the double locked position and electrically uncoupled in the double unlocked position. The contacts can be electrically coupled to the antenna of the RFID tag 180 such that the RFID tag 180 is unable to transmit a signal when the handcuff device is in the double unlocked position. This would ensure that the handcuff device is in the double locked position when the tightness test is confirmed. In some implementations, the contacts can provide information regarding the double lock mechanism to the RFID tag 180 so that the RFID tag's 180 signal can include the double lock status information while still allowing the tightness test to be confirmed.

The double lock sensor 182 shown in FIGS. 2A-6 is disposed adjacent an end of the lock spring 160 such that, when the lock spring 160 is disposed in the double locked position, the end of the lock spring 160 is detectable by the double lock sensor 182. However, the double lock sensor 182 is configured such that, when the lock spring 160 is disposed in the double unlocked position, the end of the lock spring 160 is either not detectable by the double lock sensor 182 or the lock spring 160 is far enough from the double lock sensor 182 (in implementations in which the double lock sensor is a distance sensor) for the processor to determine that the lock spring 160 is in the double unlocked position.

The processor 172 is in operative communication with the double lock sensor 182. The computer-readable instructions cause the processor 172 to cause the system memory 174 to receive double lock position input from the double lock sensor 182. The double lock input can be based on whether the double lock sensor 182 senses the end of the lock spring 160.

The computer-readable instructions then cause the processor 172 to generate a double lock signal if the system memory 174 receives the double lock position input. A generated double lock signal represents that the device 100 is double locked.

In some implementations, the double lock input can be based on a distance from the double lock sensor to the end of the lock spring. In such implementations, the computer-readable instructions cause the processor to compare the double lock input to a predetermined double lock threshold. The computer-readable instructions would then cause the processor to generate a double lock signal if the double lock input is below the predetermined double lock threshold.

In either or both implementations, the instructions further cause the processor 172 to cause the double lock signal to be wirelessly transmitted from the device 100 by any of the means discussed above.

A heart-rate sensor 184 is disposed on the casing 110 of the device 100 shown in FIGS. 2A-6 and is positioned to sense a heartbeat of the detainee through the detainee's wrist when disposed within the closed loop 102. However, in some implementations, the heart-rate sensor can be disposed along any portion of the device capable of sensing a heartbeat of the detainee through the detainee's wrist when disposed within the closed loop.

The processor 172 is in operative communication with the heart-rate sensor 184. The computer-readable instructions cause the processor 172 to cause the system memory 174 to receive heart-rate input from the heart-rate sensor 184. The heart-rate input can relate to the heart-rate of the detainee when the detainee's wrist is disposed within the closed loop 102.

The computer-readable instructions then cause the processor 172 to compare the received heart-rate input to a predetermined heart-rate threshold. This heart-rate threshold can be based on a predetermined acceptable minimum heart-rate of the detainee.

The computer-readable instructions then cause the processor 172 to generate a heart-rate signal if the heart-rate input is below the predetermined heart-rate threshold. A determination that the heart-rate input is below the predetermined heart-rate threshold could represent that the detainee's heart-rate has decreased to an unsafe level.

In some implementations, the computer-readable instructions can further cause the processor to compare the received heart-rate input to a second predetermined heart-rate threshold. This second heart-rate threshold can be based on a predetermined acceptable maximum heart-rate from the heart-rate of the detainee.

In such implementations, the computer-readable instructions can then cause the processor to generate a second heart-rate signal if the heart-rate input is above the second predetermined heart-rate threshold. A determination that the heart-rate input is above the second predetermined heart-rate threshold could represent that the detainee's heart-rate has increased to an unhealthy level.

In either or both implementations, the instructions further cause the processor 172 to cause the heart-rate signal and/or the second heart-rate signal to be wirelessly transmitted from the device 100 by any of the means discussed above.

A temperature sensor 186 is disposed on the casing 110 of the device 100 shown in FIGS. 2A-6 and is positioned to sense a temperature of the detainee through the detainee's wrist when disposed within the closed loop 102. However, in some implementations, the temperature sensor can be disposed along any portion of the device capable of sensing a temperature of the detainee through the detainee's wrist when disposed within the closed loop.

The processor 172 is in operative communication with the temperature sensor 186. The computer-readable instructions cause the processor 172 to cause the system memory 174 to receive temperature input from the temperature sensor 186. The temperature input can relate to the temperature of the detainee when the detainee's wrist is disposed within the closed loop 102.

The computer-readable instructions then cause the processor 172 to compare the received temperature input to a predetermined temperature threshold. This temperature threshold can be based on a predetermined acceptable minimum temperature of the detainee.

The computer-readable instructions then cause the processor 172 to generate a temperature signal if the temperature input is below the predetermined temperature threshold. A determination that the temperature input is below the predetermined temperature threshold could represent that the detainee's temperature has decreased to an unsafe level.

In some implementations, the computer-readable instructions can further cause the processor to compare the received temperature input to a second predetermined temperature threshold. This second temperature threshold can be based on a predetermined acceptable maximum temperature from the temperature of the detainee.

In such implementations, the computer-readable instructions can then cause the processor to generate a second temperature signal if the temperature input is above the second predetermined temperature threshold. A determination that the temperature input is above the second predetermined temperature threshold could represent that the detainee's temperature has increased to an unsafe level.

In either or both implementations, the instructions further cause the processor 172 to cause the temperature signal and/or the second temperature signal to be wirelessly transmitted from the device 100 by any of the means discussed above.

An accelerometer 188 is disposed on the casing 110 of the device 100 shown in FIGS. 2A-6 and is positioned to sense acceleration of the detainee through the detainee's wrist when disposed within the closed loop 102. However, in some implementations, the accelerometer can be disposed along any portion of the device capable of sensing an acceleration of the detainee through the detainee's wrist when disposed within the closed loop.

The processor 172 is in operative communication with the accelerometer 188. The computer-readable instructions cause the processor 172 to cause the system memory 174 to receive acceleration input from the accelerometer 188. The acceleration input can relate to the acceleration of the detainee when the detainee's wrist is disposed within the closed loop 102.

The computer-readable instructions then cause the processor 172 to compare the received acceleration input to a predetermined acceleration threshold. This acceleration threshold can be based on a predetermined acceptable maximum acceleration of the detainee.

The computer-readable instructions then cause the processor 172 to generate an acceleration signal if the acceleration input is above the predetermined acceleration threshold. A determination that the acceleration input is above the predetermined acceleration threshold could represent that the detainee is attempting to free themselves from the device 100.

In some implementations, the computer-readable instructions can further cause the processor to compare the received acceleration input to a second predetermined acceleration threshold. This second acceleration threshold can be based on a predetermined acceptable minimum acceleration from the acceleration of the detainee.

In such implementations, the computer-readable instructions can then cause the processor to generate a second acceleration signal if the acceleration input is below the second predetermined acceleration threshold. A determination that the acceleration input is below the second predetermined acceleration threshold could represent that the detainee is unconscious.

In either or both implementations, the instructions further cause the processor 172 to cause the acceleration signal and/or the second acceleration signal to be wirelessly transmitted from the device 100 by any of the means discussed above.

The device 100 can also include a microphone and/or a speaker 190 to receive and/or output audio, respectively. The processor 172 is in operative communication with the microphone and/or a speaker 190. The computer-readable instructions can cause the processor 172 to cause the system memory 174 to receive audio input from the microphone 190 and to save the audio input within the system memory 174 or wirelessly transmit the audio input from the device 100 by any of the means discussed above. The computer-readable instructions can also cause the processor 172 to receive an audio input, either from the system memory 174 or from an external source. The computer-readable instructions then cause the processor 172 to cause speaker 190 to output sound based on the audio input.

For any of the inputs and/or signals discussed above, the computer-readable instructions can cause the processor 172 to cause the system memory 174 to add a timestamp or any other metadata to the input and/or signal.

The device 100 further includes a battery 192 disposed within the casing chamber 122. The battery 192 provides electrical energy to the controller 170 and the various electronic sensors discussed herein. However, in some implementations, the device includes any other onboard power source capable of providing electrical energy to the controller and the various electronic sensors.

The device 100 also includes two charging ports 194 located on the outer surface of the end of the casing 110 opposite the fixed arm 130 and movable arm 140. The charging ports 194 are in electrical communication with the battery 192. An external electrical power source can be electrically coupled to the charging ports 194 to charge the battery 192 through the charging ports 194.

In some implementations, the cuffs do not include a battery. In some implementations, the handcuff device includes only passive sensors and/or mechanical switches that do not require an electrical power source.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise.

The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1.-39. (canceled)

40. A smart handcuff device, the device comprising:
a casing defining a casing chamber;
a movable arm hingedly coupled to the casing, wherein a distal end portion of the movable arm includes one or more arm teeth, wherein the casing and the movable arm are configurable to at least partially form a closed loop having an inwardly facing surface;
a locking mechanism disposed within the casing chamber, the locking mechanism including:
a pawl having one or more pawl teeth for engaging the arm teeth, wherein the pawl is movable between an engaged position and a disengaged position, wherein the one or more pawl teeth are engageable with the one or more arm teeth in the engaged position and the one or more pawl teeth are disengaged from the one or more arm teeth in the disengaged position, and
a lock spring for biasing the pawl toward the engaged position, wherein the pawl is urgable toward the disengaged position; and
a distance test indicator disposed along an inwardly facing surface of the closed loop and configured to be detectable by an external device.

41. The device of claim 40, wherein the distance test indicator comprises one or more magnets.

42. The device of claim 40, wherein the distance test indicator comprises one or more RFID tags.

43. The device of claim 40, wherein the locking mechanism is a double locking mechanism, wherein the lock spring is slidable between a double locked position and a double unlocked position, wherein a portion of the lock spring prevents the pawl from moving between the engaged position and the disengaged position in the double locked position, wherein the portion of the lock spring does not prevent the pawl from moving between the engaged position and the disengaged position in the double unlocked position.

44. The device of claim 43, wherein the double locking mechanism includes a double lock switch, wherein the double lock switch includes a set of contacts, wherein the contacts are electrically coupled in the double locked position and electrically uncoupled in the double unlocked position.

45. The device of claim 44, wherein the contacts are electrically coupled to the antenna of the RFID tag such that the RFID tag is unable to transmit a signal when the handcuff device is in the double unlocked position.

46. The device of claim 45, wherein the contacts provide information regarding the double lock mechanism to the RFID tag so that the RFID tag's signal includes double lock status information.

47. The device of claim 45, wherein the double lock signal includes a time stamp.

48. The device of claim 40, wherein the device does not include a power source.

49. A smart handcuff system, the system comprising:
the device of claim 40; and
a second handcuff coupled to the device.

50. The system of claim 49, wherein the device is a first device of claim 40, wherein the second handcuff is a second device of claim 40.

51. The device of claim 40, further including a controller having a processor and a system memory, the processor being in operative communication with the distance sensor, wherein the processor executes computer-readable instructions stored on the system memory, the instructions causing the processor to:
cause the system memory to receive distance input from the distance sensor,
compare the distance input to a predetermined distance threshold, and
generate a distance signal if the distance input is below the predetermined distance threshold.

52. The device of claim 51, wherein the distance signal includes a timestamp.

53. The device of claim 51, wherein the instructions further cause the processor to cause the distance signal to be wirelessly transmitted from the device.

54. The device of claim 53, further comprising a Bluetooth transceiver.

55. The device of claim 40, further comprising a microphone.

56. The device of claim 40, further comprising a speaker.

57. The device of claim 40, further comprising an onboard power source.

58. The device of claim 57, further comprising one or more charging ports for providing electrical energy to the power source.

59. The device of claim 40, further comprising a distance sensor configured to measure the distance from the distance sensor to a surface facing the inwardly facing surface of the closed loop.

60. The device of claim 59, further including a controller having a processor and a system memory, the processor being in operative communication with the distance sensor, wherein the processor executes computer-readable instructions stored on the system memory, the instructions causing the processor to:
cause the system memory to receive distance input from the distance sensor,
compare the distance input to a predetermined distance threshold, and
generate a distance signal if the distance input is below the predetermined distance threshold.
